(19) United States
(12) Patent Application Publication
(10) Pub. No.: US 2026/0142265 A1
(43) Pub. Date: May 21, 2026

(54) TRACTION BATTERY PACK IMMERSION THERMAL MANAGEMENT SYSTEM WITH LIQUID COOLANT CHANNELS ESTABLISHED BY BATTERY CELLS

(71) Applicant: Ford Global Technologies, LLC, Dearborn, MI (US)

(72) Inventor: Xiaogang Zhang, Novi, MI (US)

(21) Appl. No.: 18/952,367

(22) Filed: Nov. 19, 2024

(51) Int. Cl. H01M 10/643; H01M 10/613; H01M 10/625; H01M 10/6568; H01M 50/213; H01M 50/367

(52) U.S. Cl. CPC H01M 10/643; H01M 10/613; H01M 10/625; H01M 10/6568; H01M 50/213; H01M 50/367

(57) ABSTRACT

A traction battery pack immersion thermal management system includes an enclosure assembly and cylindrical battery cells housed within a cell compartment of the enclosure. The cylindrical battery cells contact each other to establish a perimeter of a liquid coolant channel within the enclosure. The perimeter of the liquid coolant channel can be provided, in some examples, by no more than three cylindrical battery cells.

### TECHNICAL FIELD

This disclosure details exemplary immersion thermal management systems having battery cell that contact each other to establish coolant channels.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, coolant can be moved through the traction battery pack to help manage thermal energy within the traction battery pack.

### SUMMARY

In some aspects, the techniques described herein relate to a traction battery pack immersion thermal management system, including: an enclosure assembly; and a plurality of cylindrical battery cells housed within a cell compartment of the enclosure, the plurality of cylindrical battery cells contacting each other to establish a perimeter of a liquid coolant channel within the enclosure.

In some aspects, the techniques described herein relate to an immersion thermal management system, wherein the complete perimeter of the liquid coolant channel is provided by no more than three cylindrical battery cells.

In some aspects, the techniques described herein relate to an immersion thermal management system, wherein the liquid coolant channel has a triangular profile.

In some aspects, the techniques described herein relate to an immersion thermal management system, wherein the plurality of battery cells each extend longitudinally along a battery cell axis, wherein the liquid coolant channel extends longitudinally along a liquid coolant channel axis that is parallel to the battery cell axes.

In some aspects, the techniques described herein relate to an immersion thermal management system, wherein the plurality of cylindrical battery cells are configured to vent into a venting compartment.

In some aspects, the techniques described herein relate to an immersion thermal management system, further including at least one conduit spanning through the venting compartment from the cell compartment to a coolant collection compartment, the at least one conduit configured to communicate liquid coolant from the cell compartment to the coolant collection compartment.

In some aspects, the techniques described herein relate to an immersion thermal management system, wherein the venting compartment is sandwiched between the cell compartment and the coolant collection compartment.

In some aspects, the techniques described herein relate to an immersion thermal management system, wherein the plurality of cylindrical battery cells are vertically above the venting compartment.

In some aspects, the techniques described herein relate to an immersion thermal management system, wherein the plurality of cylindrical battery cells each vent through a floor of the cell compartment.

In some aspects, the techniques described herein relate to an immersion thermal management system, wherein the at least one conduit opens to a liquid coolant channel.

In some aspects, the techniques described herein relate to an immersion thermal management system, wherein the complete perimeter of the liquid coolant channel is provided by more than three cylindrical battery cells.

In some aspects, the techniques described herein relate to an immersion thermal management system, wherein the perimeter is circumferentially continuous.

In some aspects, the techniques described herein relate to an immersion thermal management system, wherein the enclosure assembly includes a tray and a cover.

In some aspects, the techniques described herein relate to the perimeter being a complete perimeter.

In some aspects, the techniques described herein relate to a traction battery pack immersion thermal management system, including: a plurality of battery cells that contact each other to establish a perimeter of a liquid coolant channel.

In some aspects, the techniques described herein relate to an immersion thermal management system, wherein the plurality of battery cells are held in a cell compartment within an enclosure assembly, wherein the plurality of battery cells vent to a venting compartment that is adjacent to the cell compartment.

In some aspects, the techniques described herein relate to an immersion thermal management system, wherein the perimeter is provided by no more than three battery cells.

In some aspects, the techniques described herein relate to an immersion thermal management system, wherein the plurality of battery cells each extend longitudinally along a battery cell axis, wherein the liquid coolant channel extends longitudinally along a liquid coolant channel axis that is parallel to the battery cell axes.

In some aspects, the techniques described herein relate to an immersion thermal management system, wherein the plurality of battery cells are a plurality of cylindrical battery cells.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a highly schematic view of the battery pack from FIG. 1 along with a schematic view of an associated immersion thermal management system according to an exemplary aspect of the present disclosure.

FIG. 3 illustrates a perspective view of a battery cell from the battery pack of FIG. 2.

FIG. 4 illustrates a top view of the battery pack of FIG. 2 with an enclosure cover removed.

FIG. 5 illustrates a section view through the battery pack of FIG. 2 taken at line 5-5 in FIG. 4.

FIG. 6 illustrates a close-up view of an area of FIG. 4.

### DETAILED DESCRIPTION

An immersion thermal management system can be used to manage thermal energy in a traction battery pack, which can include a plurality of battery cells and other components held within an enclosure assembly. The immersion thermal management system uses a liquid coolant, such as dielectric liquid, to manage thermal energy. The coolant can be used to cool the battery cells, for example. This disclosure is directed toward communicating the coolant using coolant channels established entirely by the battery cells.

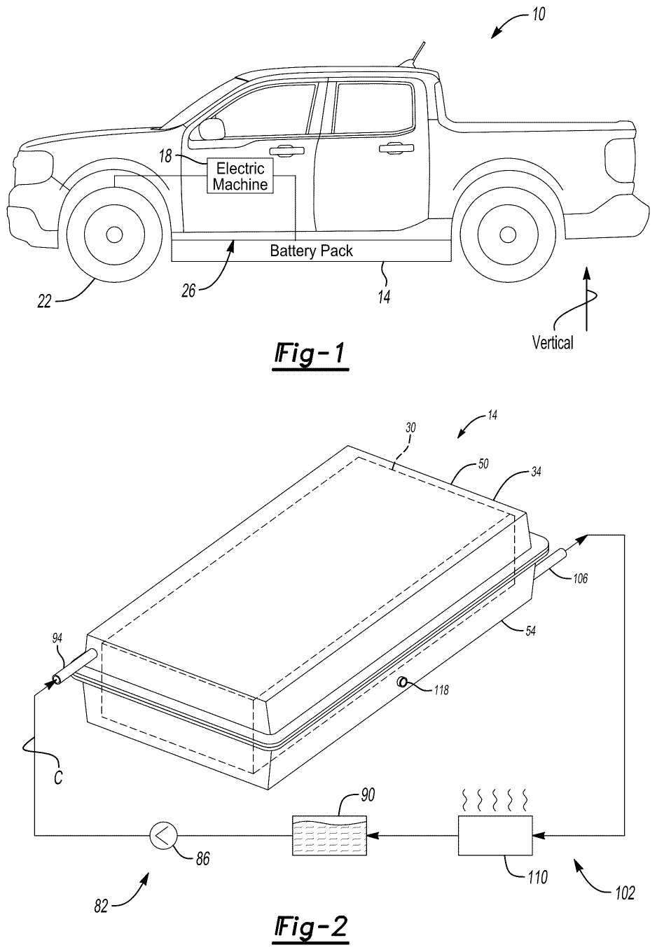

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

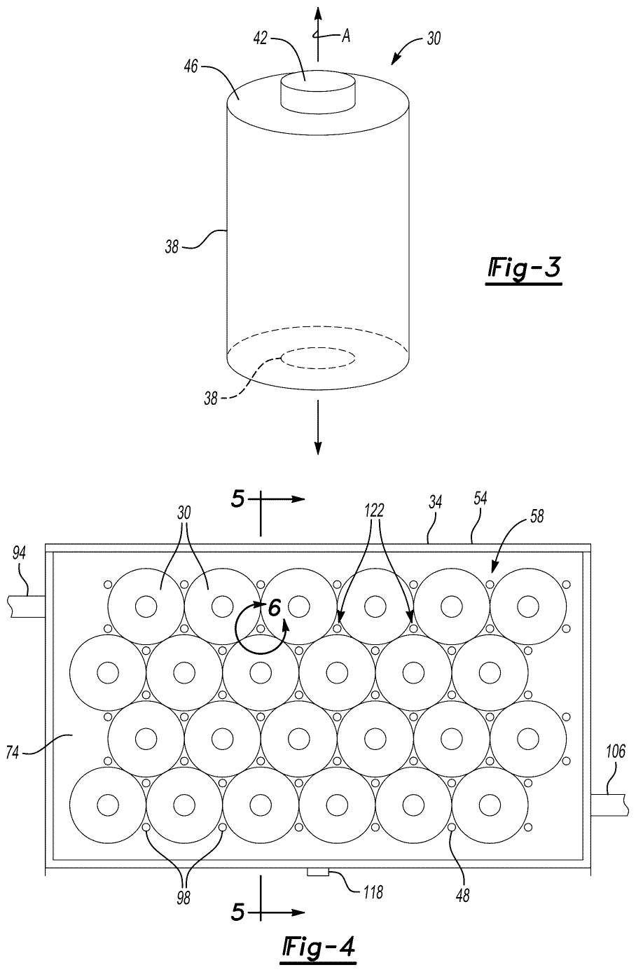

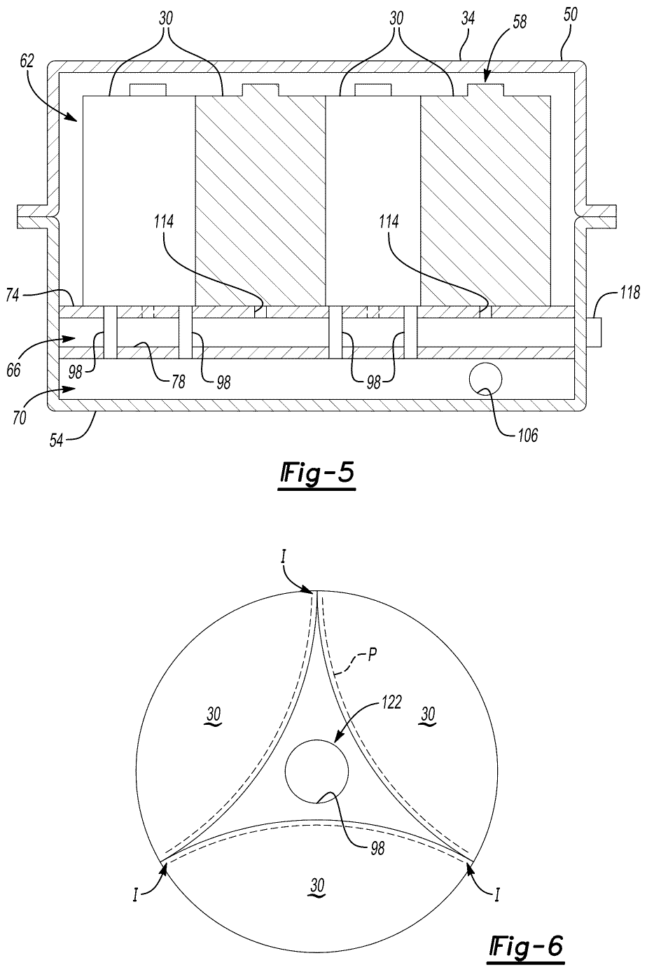

With reference now to FIGS. 2-6, an example immersion thermal management system is utilized to manage thermal energy levels within the battery pack 14. In the exemplary embodiment, the system is utilized to cool components of the battery pack 14. In other examples, the system instead or additionally heats components of the battery system.

In this example, the battery pack 14 includes a plurality of individual battery cells 30 held within an enclosure assembly 34. The example battery cells 30 are cylindrical battery cells having a jellyroll-style electrode structure housed within an outer casing 38. A cap 42 of the outer casing 38 provides a positive terminal at a first axial end of the cylindrical cell 30. A ring 46 of the outer casing 38 provides a negative terminal at the first axial end of the cell 30. The cells 30 are configured to, if needed, vent through vent 48 at an opposite axial end of the cell 30.

Although the cells 30 are disclosed as cylindrical cells, other types of cells could be used in other examples. For example cells having other geometries (lithium-ion pouch-style, etc.), other chemistries (nickel-metal hydride, lead-acid, etc.), or both could alternatively be utilized within the scope of this disclosure.

The enclosure assembly 34 includes, in this example, an enclosure cover 50 joined to an enclosure tray 54 to provide an interior area 58 within the enclosure assembly 34. The enclosure cover 50 can be secured to the enclosure tray 54 utilizing welds, for example. While welding is mentioned, the enclosure cover 50 and the enclosure tray 54 could be secured to each other using other fluid-tight connection techniques, such as adhesive. The enclosure assembly 34 can vary in size, shape and configuration within the scope of this disclosure.

The interior area 58 is partitioned into a cell compartment 62, a venting compartment 66, and a coolant collection compartment 70. In the exemplary embodiment, the venting compartment 66 is sandwiched vertically between the cell compartment 62 and the coolant collection compartment 70. In this example, the venting compartment 66 is vertically beneath the cells 30. Vertical, for purposes of this disclosure, is with reference to ground in a general orientation of the battery pack 14 when utilized within the electrified vehicle 10. In an example, a height of the venting compartment 66 can be about 10 millimeters and a height of the coolant collection compartment 70 can be about 6 millimeters.

A floor 74 of the cell compartment 62 separates the cell compartment 62 from the venting compartment 66. A floor 78 of the venting compartment 66 separates the venting compartment 66 from the coolant collection compartment 70.

The immersion thermal management system includes a coolant delivery system 82 that uses a pump 86 to communicate coolant C from a coolant supply 90 through an inlet port 94 into the cell compartment 62. The coolant C flows through the cell compartment 62 to take on thermal energy from the battery cells 30 and other components.

Within the cell compartment 62, the cells 30 are immersed within the coolant C such that the coolant C can take on thermal energy from the cells 30 and surrounding components of the battery pack 14. The coolant C can be a liquid, non-conductive (i.e., dielectric) coolant C. The thermal management system is considered an immersion thermal management system at least because portions of the battery pack 14, here at least the battery cells 30, are immersed in the coolant C.

The coolant C exits the cell compartment 62 through at least one conduit 98 spanning through the venting compartment 66 from the cell compartment 62 to the coolant collection compartment 70. The conduits 98 are each configured to communicate coolant C from the cell compartment 62 to the coolant collection compartment 70. The venting compartment 66 is adjacent to the cell compartment 62 but is fluidly isolated from the cell compartment 62 and the coolant collection compartment 70. That is, the coolant C is blocked from entering the venting compartment 66.

The immersion thermal management system includes a coolant return system 102 that communicates coolant C from the coolant collection compartment 70 within the interior area 58 enclosure assembly 34 back to the coolant supply 90. The coolant return system 102 includes, among other things, at least one outlet port 106 from the battery pack 14. Coolant from the at least one outlet port 106 can flow to a thermal management assembly, such as a heat exchanger 110. At the heat exchanger 110, thermal energy can be transferred from the coolant C. The coolant C can then move from heat exchanger 110 to the coolant supply 90. The pump 86 can draw coolant C from the coolant supply 90 for circulation back through the battery pack 14.

During a thermal event where one or more of the cells 30 vent, the cells 30 can expel vent byproducts through the associated vent 48. The vent byproducts can move through a respective floor vent opening 114 in the floor 74 into the venting compartment 66. The vent byproducts can be discharged from the venting compartment 66 and from the battery pack 14 through a vent 118.

The battery cells 30 each extend along a longitudinal axis A. The battery cells 30 are disposed on the floor 74 such that their longitudinal axes extend vertically.

The battery cells 30 are positioned so that the battery cells 30 contact each other at interfaces I (FIG. 6). This enables the battery cells 30 to establish an enclosed perimeters P of a plurality of liquid coolant channels 122.

In this example, exactly three of the battery cells 30 are used to establish a complete, circumferentially continuous perimeter P of each of the liquid coolant channels 122. In other examples, more than three of the battery cells 30 could be used to establish each perimeter.

The liquid coolant channels 122 have a triangular profile. Each of the three sides is provided by one of the cells 30. As the cells 30 are cylindrical, the contact between the cells 30 at the rounded outer edges can be line contact.

The liquid coolant channels 122 each extend longitudinally along a respective liquid coolant channel axis that is parallel to the longitudinal axes of the battery cells 30. The liquid coolant channel axis extends out of the page and perpendicular to a plane of the page in FIG. 6.

Coolant C can communicate through the liquid coolant channels 122 from an upper region of the cell compartment 62 through the cells 30 to a lower region of the cell compartment 62 where the coolant C can exit the cell compartment 62 through the conduits 98 and move into the coolant collection compartment 70.

As the coolant C is communicated through liquid coolant channels 122 that are established entirely by the battery cells 30, there is no requirement for additional structures, such as pipes, to be incorporated into these areas of the battery pack 14. Providing the liquid coolant channels 122 with the battery cells 30 can facilitate increasing an energy density of the battery pack 14 as more battery cells 30, which are typically spaced from each other, can be fit within a given area.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack immersion thermal management system, comprising:
an enclosure assembly; and
a plurality of cylindrical battery cells housed within a cell compartment of the enclosure, the plurality of cylindrical battery cells contacting each other to establish a perimeter of a liquid coolant channel within the enclosure.

2. The immersion thermal management system of claim 1, wherein the perimeter of the liquid coolant channel is provided by no more than three cylindrical battery cells.

3. The immersion thermal management system of claim 1, wherein the liquid coolant channel has a triangular profile.

4. The immersion thermal management system of claim 1, wherein the plurality of battery cells each extend longitudinally along a battery cell axis, wherein the liquid coolant channel extends longitudinally along a liquid coolant channel axis that is parallel to the battery cell axes.

5. The immersion thermal management system of claim 1, wherein the plurality of cylindrical battery cells are configured to vent into a venting compartment.

6. The immersion thermal management system of claim 5, further comprising at least one conduit spanning through the venting compartment from the cell compartment to a coolant collection compartment, the at least one conduit configured to communicate liquid coolant from the cell compartment to the coolant collection compartment.

7. The immersion thermal management system of claim 6, wherein the venting compartment is sandwiched between the cell compartment and the coolant collection compartment.

8. The immersion thermal management system of claim 6, wherein the plurality of cylindrical battery cells are vertically above the venting compartment.

9. The immersion thermal management system of claim 6, wherein the plurality of cylindrical battery cells each vent through a floor of the cell compartment.

10. The immersion thermal management system of claim 6, wherein the at least one conduit opens to a liquid coolant channel.

11. The immersion thermal management system of claim 1, wherein the perimeter of the liquid coolant channel is provided by more than three cylindrical battery cells.

12. The immersion thermal management system of claim 1, wherein the perimeter is circumferentially continuous.

13. The immersion thermal management system of claim 1, wherein the enclosure assembly includes a tray and a cover.

14. The immersion thermal management system of claim 1, wherein the perimeter is a complete perimeter.

15. A traction battery pack immersion thermal management system, comprising:
a plurality of battery cells that contact each other to establish a perimeter of a liquid coolant channel.

16. The immersion thermal management system of claim 15, wherein the plurality of battery cells are held in a cell compartment within an enclosure assembly, wherein the plurality of battery cells vent to a venting compartment that is adjacent to the cell compartment.

17. The immersion thermal management system of claim 15, wherein the perimeter is provided by no more than three battery cells.

18. The immersion thermal management system of claim 15, wherein the plurality of battery cells each extend longitudinally along a battery cell axis, wherein the liquid coolant channel extends longitudinally along a liquid coolant channel axis that is parallel to the battery cell axes.

19. The immersion thermal management system of claim 15, wherein the plurality of battery cells are a plurality of cylindrical battery cells.
